(19) United States
(12) Patent Application Publication
(10) Pub. No.: US 2005/0278154 A1
(43) Pub. Date: Dec. 15, 2005

(54) Systems and methods for high level simulator control

(76) Inventors: Henock A. Abebe, Plano, TX (US); Darryl Okahata, Santa Rosa, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/868,226

(22) Filed: Jun. 15, 2004

(51) Int. Cl. G06F 17/10

(52) U.S. Cl. 703/2

(57) ABSTRACT

A method comprises receiving a netlist file in a simulator, parsing the netlist file to provide a parsed internal representation of the netlist within the simulator, flattening the parsed representation to provide a flattened internal representation of components and connection of the components from the netlist, converting the flattened representation of components and connections into a mathematical matrix, solving the matrix, generating output from the simulator of desired data as a result of the solving, and controlling, by a user, simulation operation during at least one of the parsing, flattening, converting and generating. A computer program product comprises computer usable medium having computer readable program code means embodied therein for causing a computer to simulate at least one of a circuit, a system, and a network and enable a user to control operation of the simulation during at least one of the parsing, flattening, converting and generating steps of simulation.

### TECHNICAL FIELD

The present invention is related to circuit, system and network simulators and more specifically to systems and methods for simulator control that allows application developers to develop high level application that can easily and rapidly be integrated into a simulator.

### BACKGROUND OF THE INVENTION

Simulation Program with Integrated Circuit Emphasis (SPICE) is a simulation tool used by engineers throughout the world for simulating circuits of all types. Since its development at the University of California Berkeley, SPICE has been commercialized and modified by a large number of vendors and also adopted and modified by electronic product companies for their own in-house use. Examples of existing commercially available circuit, system and/or network simulators include VIRTUOSO SPECTRE SIMULATOR™ from CadenceDesign Systems, Inc., HSPICE® Simulator from Synopsys, Inc, a portion of the Advanced Design System™ offered by Agilent Technologies, and the like.

In using circuit, system or network simulators, engineers or technicians create computer representations of circuit, system or network designs and feed the representations various input signals to observe the resultant output signals. Since such simulation is carried out using software, the designer can modify the circuit, system or network for best results before actually building the circuit, system or network, which saves costs, time and frustration. Existing simulators typically handle only one network or one topology, and analyze only that network or topology.

Developers and simulator users often need to have significant expertise in computer programming, and access to the simulator's source code in order to make significant changes to how the simulator operates. There are some existing programs that control the operation of a simulator, including OASIS™. However, the external programmability that is available through these programs control operation of the simulator using an external process such as mechanisms external to the simulator. There are several disadvantages to controlling the operation of the simulator in this fashion. For example, providing capabilities to enable enhanced interfaces using existing external programmability often requires complex and tedious source code modifications, as well as significant, in-depth simulator operation knowledge.

In existing simulators a designer typically creates a text file which contains a description of a circuit, system or network. This file is commonly referred to as a netlist. In existing simulators control information in this netlist generally cannot be changed. The netlist file in traditional simulators describes the underlying system that is being simulated. The netlist contains a textual description of how components are connected together and what their component values are, what types of analysis to perform, what kinds of signals to input, and what kinds of variables or outputs to display or produce. Traditional simulators do not provide a mechanism to control how the simulator goes about simulating the system described in the netlist, such as the nature of output, except as specified within the netlist. The netlist is fed into the simulator and the simulator interprets this text file to produce output. If the designer wishes to change the circuit, system or network design, wants to achieve different results, or wants to experiment, they must modify the text file and rerun the simulation. This can be a very tedious process. Thus, a designer could repeatedly be required to create a text file, run the simulator, create a text file, run the simulator, etc. May 18, 1999 Antrim Design Systems, Inc. issued a press release describing a simulator that included an integrated simulation control language, based on PERL 5.0™ and that provided access to simulation controls, measurements and results.

Some existing simulators allow the user to create the netlist text file graphically, through a schematic capture program. The user creates a schematic graphically and a tool creates the text file based upon the graphical schematic and passes the text file to a simulator. Thus, changes to the graphical schematic result in regeneration of the text file and resubmission to the simulation. Some tools allow scripting and programmability inside the graphical schematic tool. However, these tools still require scripting or programming in the schematic capture that runs the simulation.

### SUMMARY

The present invention is directed to a system and method which provides a programmable simulator which in turn provides a mechanism that allows developers and users to program or control certain operations of the simulator. This programming is preferably carried out at a high level so as to make this capability accessible to users with only a moderate amount of expertise in computer programming, and also accessible to users who do not have access to the simulator's executable code. Resultantly, providing access to proprietary source code can be avoided.

The present systems and methods enable a user to write or specify a program that runs inside a simulator and controls how the simulator functions and operates. The present invention enables a user to delete subsystems, parse the manner in which components are connected, reconnect the components in different formats, and perform additional simulations. Therefore, without going back to that netlist file, a user may take whatever system is defined in the netlist file and isolate different parts of the system and carry out types of simulations and the like, without changing the netlist file.

The present systems and methods greatly enhance simulator usability by providing a much easier-to-use programmable simulator interface that does not require significant, in-depth knowledge of how the simulator operates, or access to the simulator's proprietary source code, for use. In accordance with the present invention internal programmability, a mechanism internal to the simulator, provides various capabilities, such as modifying the topology of a network, handling multiple disjoint networks in a single simulation, tracking dependencies between different networks, enabling saving of simulation results to multiple files, enable use of data from previous simulations and analyses, carrying out a sequence of operations, enabling iterative and conditional operations, enabling creation of simulation components on the fly, and the like. These capabilities in turn enable easier development of higher level features and interfaces, in a more general manner.

An embodiment of a method may in accordance with the present invention comprise receiving a netlist file in a simulator, parsing the netlist file to provide an internal representation of the netlist within the simulator, flattening the internal representation to provide an internal simulator representation of components and connection of the components from the netlist, converting the internal representation of components and connections into a mathematical matrix, solving the matrix, generating output from the simulator of desired data as a result of the solving, and a user controlling or modifying at least one of the parsing, flattening, converting and generating steps.

A computer program product may in accordance with at least one embodiment of the present invention comprise computer usable medium having computer readable program code means embodied therein for causing a computer to simulate at least one of a circuit, a system, and a network and enable a user to control operation of the simulation during at least one of the parsing, flattening, converting and generating steps of a simulation.

At least one embodiment of a system for high-level simulation control in accordance with the present invention comprises a simulator adapted to execute on a processor-based device. The simulator is preferably enabled to provide user selective control of simulation operation during various steps of simulation. For example, the user may selectively control simulation operation during parsing of a netlist by the simulator, flattening of a parsed internal representation of the netlist, conversion of the flattened internal representation and/or generation of output.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is a flowchart of an embodiment of the present methods; and

FIG. 2 is a diagrammatic illustration of a system employing an embodiment of the present systems.

### DETAILED DESCRIPTION

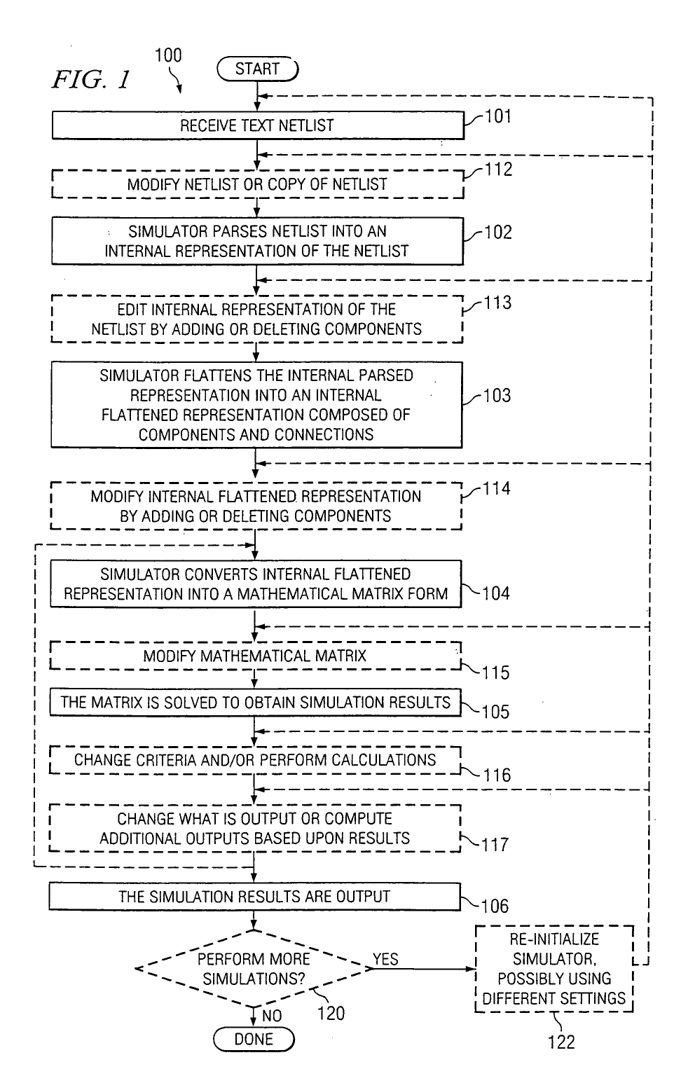

FIG. 1 is a flowchart of embodiment 100 of the present methods. For purposes of illustration and explanation this description breaks simulation of a circuit, system or network into different categories or steps, at which a user may control simulator operation in accordance with the present invention. However, the present invention may provide an interface at points not coinciding with these categories or breaks.

Generally, the simulator receives a netlist text file at 101. The simulator then converts the netlist file to an internal representation by parsing at 102. Then the simulator performs a flattening step to generate a flattened representation of the underlying components of the subcircuits in the netlist at 103. Then at 104 the flattened representation is converted into a mathematical matrix. Then that mathematical form is solved for certain inputs at 105 to generate outputs, which are output as data at 106. As one of ordinary skill in the art will appreciate, these steps or categories of simulator operation are known in the art. However, it is desirable to enable a user to control various operations of a circuit, system or network simulator. In accordance with the present invention, a user is enabled to write, for example via a scripting language, or to select a program, such as via a user interface, to control how the simulator operates at various ones of the steps as discussed in greater detail and with examples below.

When the circuit, system or network is described to the simulator in a netlist, the user may define and/or make use of building block subcircuits, as a convenience mechanism. At a lowest level the subcircuits may be groups of components. In describing a circuit, system or network in terms of subcircuits, a user may not be required to specify how each and every individual component is connected in the circuit, system or network. Thus, a user can define what subcircuits, to use, and how many, and the simulator will automatically convert each subcircuit into individual components and connect the components appropriately. Internally, a simulator reads a netlist at 101 and at 102 converts the netlist into an internal representation of the text file that the computer carrying out the simulation can easily handle. This latter action may be referred to as a parsing step (102). A subsequent step, at 103, is a flattening process. Flattening carries out conversion of subcircuits into individual components. Subcircuits may be comprised of other subcircuits, which may in turn be comprised of other subcircuits, etc. It is possible for a single subcircuit to comprise many, possibly on the order of hundreds of individual components. Flattening converts the internal netlist representation, or parsed representation, into a “flattened” representation that consists of each individual component and how they are connected together. For example, a subcircuit might be an AND gate, and the flattened representation of that AND gate may comprise the transistors that are put together in a particular arrangement to form that AND gate. At 104 the flattened representation is converted into a mathematical matrix, and various mathematical operations are performed at 105 to produce various outputs at 106.

The present invention provides programmability for the simulation in such a manner as to enable the user to control how different steps in a simulation process execute. Using the present programmability a user may add capabilities to the simulator. For example, as the netlist is received or after the simulator reads the netlist at 101, the user may intercept the netlist at 112, and change it. For example, a user may have a template of a netlist, and he may want to change it by substituting-in various subcircuits for testing. As another example, a user at 112 could create a netlist template that consists of a schematic representation of test equipment or the like. In a schematic, test equipment may produce input signals, and have provision for measuring output signals. To this end, the present invention might enable a user to define a template for such a test system with particular inputs and outputs and then the user could change what is being tested. The program might contain a template for this test system, and the program might swap out different elements to test, such as different subcircuits. For example, the user may have five different components and the user may not be quite sure which one to use in a design. The present invention enables the user to swap in each of these five components, one by one, perform various tests, and examine the output. Each of the outputs from these components could then be automatically examined to aid in determining which component best meets the user's needs. In such a case the netlist file describes the test system, and the present invention enables the user to go into the simulation without changing the netlist file each time and try out different components by inserting and replacing the components within the test system. In accordance with the present invention these changes may be carried out by editing the textural netlist representation inside the simulator.

The present systems and methods preferably provide a plurality of manners by which the user can control how the simulator operates programmatically. In order to control the simulator in accordance with the present invention, a script may be written, such as by using a scripting language, that controls how the simulation system operates. There are a plurality of manners in which this script can be provided to the simulator. For example, the script may be embedded in an existing netlist, which traditionally may only consist of a circuit, system or network description. The script preferably contains instructions as to what inputs the simulation is to use, what tests the simulation is to perform, and the nature of variables to output. In accordance with the present invention the script may be embedded in the netlist file so that the netlist file contains the original netlist plus the program delivered by the script which the user desires to be run during simulation. Thereby, if the netlist contains a script, as the simulator runs, the script is run.

Other embodiments of the present invention may make changes to a netlist in other manners. For example, the netlist might contain a script, such as programmatic instructions or computer source code, instructing the simulator to make changes to the net list. As a further example, another manner of communicating a program to the simulator may be via a separate program file. A script can be stored in a file in a predetermined location, and the netlist could contain a reference to the file that contains the script. Instead of incorporating the script into the netlist, the netlist may contain a reference that directs the simulator, such that when the netlist is read, the simulator is directed to read a separate file for commands or a script. This reference may be a command-line instruction or the like inserted into the netlist. This latter approach enables the same or different user to create reusable, complex sequence script, which becomes easy-to-use because only a reference needs to be added to the netlist to invoke the script.

Although a template may be altered at 112 by plugging in different building blocks and thereby editing the textual netlist, at 113 a similar result may be achieved by editing the parsed internal representation. However, for ease of use the present invention provides a user a choice as to where he or she wants to edit the template. As noted above, the parser converts the netlist into an internal representation at 102. The present invention enables the user to change the parsed representation of a netlist at 113, if the user so desires. Once the netlist is converted to an internal representation, the present programmable simulator enables a user to change the nature of what is output at 113. For example, after parsing at 102, the user is enabled at 113 to modify the components of the circuit, system or network, such as to add components or delete components. Such changes may be equivalent to changes that may be carried out at 112, at the textual level. In other words, the similar results may be achieved by modifying either the textual representation at 112 or in the parsed representation at 113.

After the output of the flattener at 103, changes may be made to a simulation in accordance with the present invention at 114. The output of the flattener primarily comprises individual connected components, subcircuits expanded out and converted into individual components connected to each other. At 114 a user may add and delete individual components by breaking up the circuit, system or network into multiple pieces. Modifications at 114 may be particularly useful in a system simulator, which deals with building larger building blocks, such as amplifiers, radar systems, antennas, cell phones, and the like. Some existing simulators may separate a network or system to be simulated into system components and circuit components because each is typically simulated separately. The netlist text files that these simulators read can consist of both system level elements and circuit level components. During simulation the simulator typically determines which components belong to the system simulator and which components belong to the circuit simulator. However, in accordance with the present invention the system elements and circuit components may be easily merged to provide a seamless simulation of the system and component circuits, while enabling users to change the manner in which such merging is carried out. A user may separate the system elements from the circuit level components employing the present programmable simulator. The programmable simulator can be used to take out the separated system components and circuit components, and if the user so desires, modify the system elements or the circuit level components. For example, at 114 a user may swap out different circuits with different system components for testing programmatically. Although, some existing simulators allow the use of both system-level and circuit-level components, these existing simulators do not enable users to programmatically change, add, or delete components or entire subcircuits. For users simulating a large, high level, system the present invention also enables the user to replace a system component, such as an amplifier, with a circuit level representation. The user may simulate at the very high level, but if the user needs more detail, the user can represent individual system blocks using circuit level simulations. Therefore, to obtain a more accurate simulation, an initially less accurate system model element may be replaced with a more accurate circuit level model of that element.

Converting a flattened representation into a mathematical matrix form, such as is done at 104, and solving the matrix at 105 are core parts of simulation. The present invention enables changing inputs to this core engine at 112, 113 and 114, as well as providing for directly modifying the mathematical matrix produced at 104, at 115. Near completion of step 105, an optional check for certain mathematical criteria may occur. If such a check for mathematical criteria is used, steps 104, 115, and 105 may be repeated until these certain mathematical criteria are satisfied, or some limit of reiteration is reached. Such a limit may be specified by the user, or may be some default value. At 116 such mathematical criteria may be changed, or additional, possibly unrelated, calculations may be performed and output. Additionally, if a check for mathematical criteria is used near the completion of step 105, steps 104, 115, 105 and 116 may be repeated until the mathematical criteria are satisfied, or the limit is reached. Scripting may be carried out in step 105 or 116. Scripting carried out at 105 or 116 may perform additional calculations, the results of which can then be used during a subsequent repetition of steps 104, 115, and 105, at step 115 to decide upon how to best modify the matrix. By way of example, one possible use for such scripting in step 105 or 116 may be to increase the probability of satisfying a subsequent check of mathematical criteria carried out in a repeated step 105. As a more specific example, one possible use for scripting in step 105 or 116 may be to prevent the matrix from being singular. In some cases, a circuit may have a topology and component values that cause the matrix to be singular, which results in the matrix being unsolvable, and as a result no data can be computed during a simulation. In accordance with the present invention, at step 116, a very high resistance may be added at each node, to ground. In mathematical terms, a very small number (such as in the range of 1.0e-7 to 1.0e-8) might be added to each matrix entry, along the diagonal, at step 116.

Additionally, at the output of matrix solution 105, a user may, at 117, programmatically define what is output at 106. At 117, internal variables, which are used by the program to further control how the program operates, may be manipulated, such as by indicating a nature of said output, adding variables to be output, deleting variables from the output, and/or indicating additional data to be output. For example, a user may have a set of parts and the user may wish to determine which part is best for a particular application. In accordance with the present invention, the user may write a program that runs in the simulator that simulates a circuit, system or network with different components. The output of the simulator may be examined by the program to determine if, for example, a currently simulated component meets the user's needs or not. If the component meets the user's needs the program might stop and so indicate to the user at 106. However, if the component does not meet the user's needs, the program may try other components, possibly guided by solutions provided at 105. As one of ordinary skill in the art will appreciate, there are many other uses for programmatically defining the nature of what is output at 117 as part of the present invention.

A determination may be made at 120, such as through the use of an algorithm, as to whether more simulations should be preformed, such as may be desirable to test multiple components in a simulated circuit, system or network. If it is desirable to perform more simulations, the simulator may be reinitialized at 122, to any of several restart points, such as illustrated in FIG. 1. Such a reinitialization may make use of different settings or the like.

By way of example, some interfaces that may be supported by the present invention are described below. A model extraction interface enables a mechanism to isolate a portion of a network, extract an equivalent model, and then use the extracted model results to replace the isolated portion to speed up simulation of the overall network. The equivalent model can, by way of example, be a circuit level behavior model representation. Preferably, the model extraction interface does not describe the model, but rather the process of extracting the model and integrating the model into the simulation. Advantageously, this interface enables the process of model extraction to be automated, and enables tracking of the model's operating condition so that the model can be kept valid. This operation may be transparent to the user of the simulator.

A high level analysis controller interface may also be provided. An example of an analysis controller is a parameter sweep, which runs a set of analyses several times while varying a set of network parameters. Another more sophisticated analysis controller, such as an optimizer, may use an algorithm to set network parameters, depending on the results of a previous analysis iteration. Yet another example of an analysis controller provided in accordance with the present invention is a transient assisted harmonic balance (TAHB), which runs a transient analysis to determine the initial conditions of a network or circuit, and then runs a harmonic balance analysis. The present invention enables a user to programmatically modify and/or create new analyses or tests such as described above from existing or previous analyses or tests.

The present invention enables a user to create new mathematical functions, which can then be used in design equations. Another use of the present invention is to enable changing what type of data is output, compute additional results, or decide what test or analyses to perform next, based upon current results.

Another interface may provide a capability that will enable a simulator to handle multiple networks, and that may partition the networks into sub-networks, with these networks coexisting within a single simulation, and analyzed separately. Advantageously, this enhances the speed of network or circuit design by breaking a larger problem into smaller pieces, analyzing the smaller problems and combining the results.

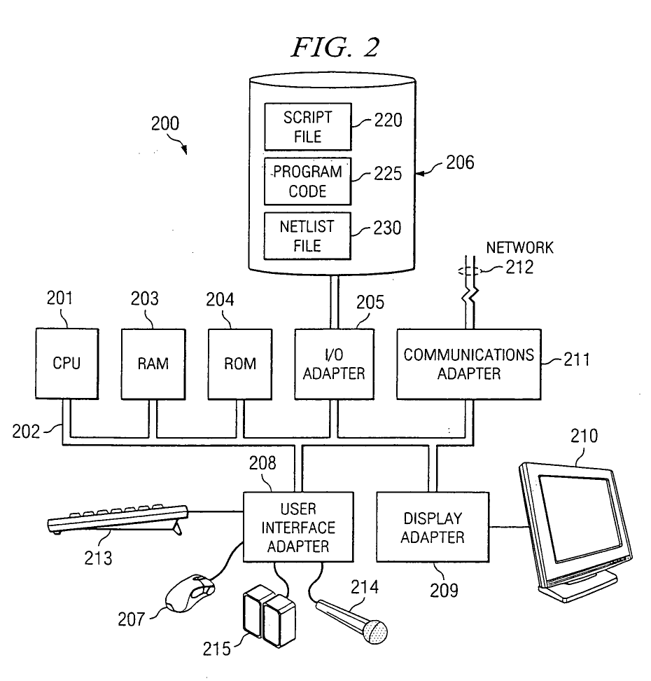

FIG. 2 is a diagrammatic illustration of a processor-based system adapted to employ at least one embodiment of the present systems. When implemented via computer-executable instructions, various elements of embodiments of the present invention and simulator are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). Readable media can include any medium that can store or transfer information.

FIG. 2 illustrates an example computer system 200 adapted according to embodiments of the present invention. That is, computer system 200 comprises an example system on which embodiments of the present invention may be implemented when carrying out a circuit, system or network simulation on computer system 200, or a connected computer. Central processing unit (CPU) 201 is coupled to system bus 202. CPU 201 may be any general purpose CPU. Suitable processors include, without limitation, HEWLETT-PACKARD's PA-8500 processor, INTEL's PENTIUM® 4 family or processors, and INTEL's ITANIUM family of processors, as examples. However, the present invention is not restricted by the architecture of CPU 201 as long as CPU 201 supports the inventive operations as described herein. CPU 201 may execute the various logical instructions according to embodiments of the present invention, including simulation related instructions. For example, CPU 201 may execute machine-level instructions according to the exemplary operational flow described above in conjunction with FIG. 1. The simulator executed by system 200 in accordance with the present invention is preferably enabled to employ a scripting language to read a script file incorporated into the netlist as discussed above. Alternatively, the simulator may employ the scripting language to look for a reference in a netlist file that refers to a separately stored scripting file and/or to read this file. To that end the simulator may also be enabled to use the scripting language employed by the present invention. The present systems and methods may employ a scripting language known as PYTHON, or the like. Providing the simulator a capability to employ the scripting language enables control of various low level details of a simulation run by the simulator in accordance with the present invention.

Computer system 200 also preferably includes random access memory (RAM) 203, which may be SRAM, DRAM, SDRAM, or the like. Computer system 200 preferably includes read-only memory (ROM) 204 which may be PROM, EPROM, EEPROM, or the like. RAM 203 and ROM 204 hold user and system data and programs, as is well known in the art.

Computer system 200 may also include input/output (I/O) adapter 205, communications adapter 211, user interface adapter 208, and display adapter 209. I/O adapter 205, user interface adapter 208, and/or communications adapter 211 may, in certain embodiments, enable a user to interact with computer system 200 in order to input information, such as the aforementioned scripts such as through use of various user interfaces as described above.

I/O adapter 205 preferably connects storage device(s) 206, such as one or more hard drive, compact disc (CD) drive, floppy disk drive, tape drive, etc., to computer system 200. The separately stored scripting file 220, as well as the program code 225 to execute the present simulator and/or simulation interface and netlist 230, may be stored on one or more of storage devices 206. The storage devices may also be utilized when RAM 203 is insufficient for the memory requirements associated with storing data for circuit, system or network simulation or simulation manipulation in accordance with the present invention. Communications adapter 211 is preferably adapted to couple computer system 200 to network 212 (e.g., an intranet, LAN, WAN or the Internet). User interface adapter 208 couples user input devices, such as keyboard 213, pointing device 207, and microphone 214 and/or output devices, such as speaker(s) 215 to computer system 200. Display adapter 209 is driven by CPU 201 to control the display on display device 210 to, for example, display a user interface, such as discussed above for inputting scripting, or the like.

It shall be appreciated that the present invention is not limited to the architecture of system 200. For example, any suitable processor-based device may be utilized, including without limitation personal computers, laptop computers, computer workstations, and multi-processor or multi-nodal servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method comprising:
receiving a netlist file in a simulator;
parsing said netlist file to provide a parsed internal representation of said netlist within said simulator;
flattening said parsed internal representation to provide a flattened internal representation of components and connection of said components from said netlist;
converting said flattened internal representation of components and connections into a mathematical matrix;
solving said matrix;
generating output from said simulator of desired data as a result of said solving; and
enabling a user control simulation operation during at least one of said parsing, flattening, converting and generating.

2. The method of claim 1 wherein said enabling comprises enabling a user to insert, in said netlist file, scripting to be executed by said simulator.

3. The method of claim 2 wherein said scripting is provided by said user.

4. The method of claim 1 wherein said enabling comprises enabling a user to insert in said netlist a command to run a program separate from said netlist to control at least one of said parsing, flattening, converting and generating.

5. The method of claim 1 wherein said enabling comprises enabling a user to insert in said netlist a command to reference a file separate from said netlist containing scripting definitions and commands controlling at least one of said parsing, flattening, converting, and generating.

6. The method of claim 1 wherein said enabling comprises enabling a user to intercept said netlist during said receiving to enable said user to change said netlist prior to said parsing.

7. The method of claim 1 wherein said enabling comprises enabling a user to intercept said netlist prior to said parsing to enable said user to change said netlist prior to said parsing.

8. The method of claim 1 wherein said enabling comprises enabling a user to replace said netlist, at least in part, prior to said parsing, enabling use of the replacement netlist during said parsing.

9. The method of claim 1 wherein said enabling comprises enabling user access to said parsed internal representation to change said parsed internal representation, prior to said flattening.

10. The method of claim 9 wherein said enabling user access comprises enabling a user to modify at least one of components, equations, and subcircuit definitions of said parsed internal representation.

11. The method of claim 9 wherein said enabling user access comprises enabling a user to add to said parsed internal representation at least one of components, equations, and subcircuit definitions.

12. The method of claim 9 wherein said enabling user access comprises enabling a user to delete from said parsed internal representation at least one of components, equations, and subcircuit definitions.

13. The method of claim 1 wherein said enabling comprises enabling a user to change output of said flattening.

14. The method of claim 13 wherein said change comprises adding components to said output of said flattening.

15. The method of claim 13 wherein said change comprises adding equations to said output of said flattening.

16. The method of claim 13 wherein said change comprises deleting components from said output of said flattening.

17. The method of claim 13 wherein said change comprises deleting equations from said output of said flattening.

18. The method of claim 13 wherein said change comprises modifying components in said output of said flattening.

19. The method of claim 13 wherein said change comprises modifying equations in said output of said flattening.

20. The method of claim 13 wherein said change comprises breaking a circuit resulting from said flattening into subcircuits.

21. The method of claim 1 wherein said enabling comprises enabling a user to indicate a nature of said output.

22. The method of claim 1 wherein said enabling comprises enabling a user to add variables to be output.

23. The method of claim 1 wherein said enabling further comprises enabling a user to delete variables from said output.

24. The method of claim 1 wherein said enabling further comprises enabling a user to compute additional data to be output.

25. The method of claim 1 wherein said enabling comprises enabling a user to employ an algorithm to determine whether further simulation should be performed.

26. The method of claim 1 wherein said enabling comprises enabling a user to script a parameter sweep to run a set of analyses while varying network parameters.

27. The method of claim 1 wherein said enabling comprises enabling a user to use an algorithm to set network parameters based on results of previous analysis.

28. The method of claim 1 wherein said enabling comprises enabling a user to run a transient analysis to determine initial conditions of a circuit and running a harmonic balance analysis based on said initial conditions.

29. The method of claim 1 wherein said enabling comprises enabling a user to describe a format for said simulator to use to save data.

30. The method of claim 1 wherein said enabling comprises enabling a user to employ a symbolic function used as part of a circuit design equation.

31. The method of claim 1 further comprising enabling said simulator to handle multiple networks with said networks partitioned into sub-networks, coexisting within said simulation, and analyzed separately.

32. A computer program product comprising:
a computer usable medium having computer readable program code means embodied therein for causing a computer to:
simulate at least one of a circuit, a system, and a network by:
receiving a netlist file;
parsing said netlist file to provide a parsed internal representation of said netlist within the simulator;
flattening said parsed internal representation to provide a flattened internal representation of components, connections of said components and equations of said netlist;
converting said flattened internal representation of components, connections and equations into a mathematical matrix;
solving said matrix; and
generating output from said simulator of desired data as a result of said solving; and
enable a user to control operation of the simulation during at least one of said parsing, flattening, converting and generating.

33. The computer program product of claim 32 wherein said computer readable program code means causes said computer to enable a user to control operation of the simulation by enabling said user to insert into said netlist file at least one of scripting to be executed by said simulator, a command to run a program separate from said netlist, and a command to reference a file separate from said netlist containing scripting definitions and commands.

34. The computer program product of claim 32 wherein said computer readable program code means causes said computer to enable a user to control operation of the simulation by enabling said user to intercept said netlist prior to said parsing to enable said user to change said netlist prior to said parsing.

35. The computer program product of claim 32 wherein said computer readable program code means causes said computer to enable a user to control operation of the simulation by enabling said user to replace said netlist, at least in part, prior to said parsing, enabling use of the replacement netlist during said parsing.

36. The computer program product of claim 32 wherein said computer readable program code means causes said computer to enable a user to control operation of the simulation by enabling said user to provide said user access to said parsed internal representation to change said parsed internal representation prior to said flattening.

37. The computer program product of claim 32 wherein said computer readable program code means causes said computer to enable a user to control operation of the simulation by enabling said user to modify at least one of components, equations, and subcircuit definitions in said parsed internal representation.

38. The computer program product of claim 32 wherein said computer readable program code means causes said computer to enable a user to control operation of the simulation by enabling said user to change output by at least one of:
breaking a circuit resulting from said flattening into subcircuits;
adding components to said output of said flattening;
adding equations to said output of said flattening;
deleting components from said output of said flattening;
deleting equations from said output of said flattening;
modifying components in said output of said flattening;
modifying equations in said output of said flattening;
indicating a nature of said output;
adding variables to be output; and
deleting variables from said output.

39. The computer program product of claim 32 wherein said computer readable program code means causes said computer to enable a user to control operation of the simulation by enabling said user to run a parameter sweep of a set of analyses, while varying network parameters.

40. The computer program product of claim 32 wherein said computer readable program code means causes said computer to enable a user to control operation of the simulation through use of an algorithm to set network parameters based on results of previous analysis.

41. The computer program product of claim 32 wherein said computer readable program code means causes said computer to enable a user to control operation of the simulation by enabling said user to run a transient analysis to determine initial conditions of a circuit and to run a harmonic balance analysis based on said initial conditions.

42. The computer program product of claim 32 wherein said computer readable program code means causes said computer to enable a user to control operation of the simulation by enabling said user to describe a format for said simulator to use to save data.

43. The computer program product of claim 32 wherein said computer readable program code means causes said computer to enable a user to control operation of the simulation by enabling said user to employ at least one symbolic function as part of a circuit design equation.

44. The computer program product of claim 32 wherein said computer readable program code means enables said simulator to handle multiple networks with said networks partitioned into sub-networks, coexisting within said simulation, analyzed separately.

45. A system for high level simulation control comprising:
a simulator adapted to execute on a processor-based device, said simulator enabled to provide user selective control of simulation operation during selected ones of parsing of a netlist by said simulator, flattening of a parsed internal representation of said netlist, conversion of said flattened internal representation and generation of output.

46. The system of claim 45 wherein said user control during said parsing comprises insertion into said netlist file at least one of scripting to be executed by said simulator, a command to run a program separate from said netlist, and a command to reference a file separate from said netlist containing scripting definitions and commands.

47. The system of claim 45 wherein said user control during said parsing comprises interception of said netlist prior to said parsing to enable said user to change said netlist prior to said parsing.

48. The system of claim 45 wherein said user control during said parsing comprises replacement of said netlist, at least in part, prior to said parsing, enabling use of the replacement netlist during said parsing.

49. The system of claim 45 wherein said user control during said flattening comprises access to said parsed internal representation to change said parsed internal representation prior to said flattening.

50. The system of claim 45 wherein said user control during said flattening comprises modification of at least one of components, equations, and subcircuit definitions in said parsed internal representation.

51. The system of claim 45 wherein said user control of said conversion of said flattened internal representation comprises at least one of:
breaking a circuit resulting from said flattening into subcircuits;
adding components to said output of said flattening;
adding equations to said output of said flattening;
deleting components from said output of said flattening;
deleting equations from said output of said flattening;
modifying components in said output of said flattening; and
modifying equations in said output of said flattening.

52. The system of claim 45 wherein said user control of said output comprises at least one of indicating a nature of said output, adding variables to be output, and deleting variables from said output.

53. The system of claim 45 wherein said user control comprises at least one of:
a parameter sweep of a set of analyses, while varying network parameters;
an algorithm to set network parameters based on results of previous analysis;
a transient analysis to determine initial conditions of a circuit and to run a harmonic balance analysis based on said initial conditions;
describing a format for said simulator to use to save data; and
employing at least one symbolic function as part of a circuit design equation.

54. The system of claim 45 wherein said simulator is adapted to handle multiple networks with said networks partitioned into sub-networks, coexisting within said simulation, analyzed separately.
